(19) United States
(12) Patent Application Publication
(10) Pub. No.: US 2014/0080524 A1
(43) Pub. Date: Mar. 20, 2014

(54) INTEGRATION OF MOBILE RADIO AND PAGING SYSTEMS

(71) Applicants: Clive Douglas Horn, Christchurch (NZ); William Mark Siddall, Christchurch (NZ)

(72) Inventors: Clive Douglas Horn, Christchurch (NZ); William Mark Siddall, Christchurch (NZ)

(21) Appl. No.: 14/032,876

(22) Filed: Sep. 20, 2013

Related U.S. Application Data
(60) Provisional application No. 61/703,711, filed on Sep. 20, 2012.

(51) Int. Cl. H04W 68/00

(52) U.S. Cl. CPC H04W 68/00
USPC 455/458

(57) ABSTRACT

Methods of integrating mobile radio systems with paging systems. Paging messages are identified by way of predetermined symbols in a symbol stream which is modulated into an RF signal. The symbols may also enable synchronisation of the receiving station to the signal and/or convey individual status messages. Symbols are preferably derived from existing symbols in the mobile radio protocol. Multiple symbols may be used to represent individual bits in the message and thereby extend the range of transmissions in the system.

### RELATED APPLICATIONS

This application claims benefit of U.S. Provisional Application No. 61/703,711, filed Sep. 20, 2012, which is incorporated by reference herein in its entirety.

### FIELD OF THE INVENTION

This invention relates to integration of land mobile radio (LMR) and paging, and particularly but not only, to use of correlation sequences in a combined radio and pager.

### BACKGROUND TO THE INVENTION

Conventional mobile radio protocols such as P25 and DMR, and paging protocols such as POCSAG and Flex are used widely for communications, particularly in public services. Paging remains a key technology for emergency service operations where it is commonly used for calling out volunteers to react to emergency scenarios.

Mobile radio terminals use a wide range of communication protocols. They may be narrowband RF transceivers for example, operating within a 12.5 kHz channel such as provided in P25 APCO, DMR or analogue radio, or operating within a 6.25 kHz channel as provided in dPMR. Alternatively they may be relatively wideband transceivers using one or more 180 kHz resource blocks as provided in LTE.

P25 radio systems typically operate in 12.5 kHz analog, digital or mixed mode using FDMA. Phase 1 radios use continuous 4 level FM (C4FM) modulation for digital transmissions at 4800 symbols per second (ie. 4800 baud) and 2 bits per symbol, yielding 9600 bits per second for overall throughput on each channel. Phase 2 radios are being developed using a 2 slot TDMA scheme.

A symbol is a waveform, a state or some other intended condition of a radio channel that persists for a fixed period of time. A sending device places symbols on the channel at a fixed and known symbol rate, and receiving devices have the job of detecting the sequence of symbols in order to reconstruct the transmitted data. Symbols are typically modulated onto an RF carrier to form and RF signal. There may be a direct correspondence between a symbol and one or more small units of data (eg. bits 1, 0) or the data may be represented by the transitions between symbols or by a sequence of many symbols. Existing paging technology sends information down to a recipient over a broad geographical range using a low symbol rate. The family of POCSAG protocols can operate at three speeds: 512, 1200 or 2400 bits per second. There are two message coding formats defined for the information content part of paging messages. Numeric messages are sent as 4 bit BCD symbols and alphanumeric messages are sent as 7 bit ASCII symbols. The related Flex synchronous protocol achieves speeds of 1600, 3200 and 6400 bits per second

A paging recipient typically has to use an alternative method of responding to the page such as a cell phone or landline. Some paging devices are capable of responding, examples of the technology includes Reflex which includes a responding path or alternatively, the use of GSM. Combined pager and cell-phone devices are described in U.S. Pat. No. 5,701,337 and U.S. Pat. No. 8,254,970, for example.

Paging solutions provide an effective means of communicating small amounts of data to a user or group of users. Traditional forms of paging technology offer very wide area coverage often being sent via sites located at high points and using relatively high powers. Such paging solutions may be private or commercial. Today, paging can be accomplished using cellular technology. One example would be the use of 3G or 4G possibly using a terminal end point that is a smart phone. The use of commercial cellular is limited by its available coverage which is generally rolled out to cover populated areas. The traditional form of paging however covers huge areas well outside commercial cellular coverage. As a result, the traditional paging systems continue to be used in specialised applications.

One such specialised application exists within the domain of emergency services. The use of traditional pagers remains common for calling out emergency responders, such as fire fighters, particularly in rural areas or in areas where the use of commercial cellular is considered an undesirable operational expense. These pagers are used to alert the users to pending jobs. Similar technology is also used in task based activity such as utilities where pagers may be used to alert suitably qualified staff to attend specific jobs.

Generally, these response scenarios require both high reliability and are time sensitive. The cellular network can become congested resulting in paged information taking a long time to arrive. Alternatively in a disaster scenario, the cellular network may simply not be available. Traditional paging networks can remain technologically favourable, given the need for wide area coverage with time sensitive and reliability requirements.

Unfortunately, traditional paging systems are becoming less attractive from a business case perspective for operators. In some cases, the specific user groups have deployed and run their own networks. In other cases, commercial operators have either shut down or are planning to shutdown traditional paging networks. LMR networks are also wide area and cover similar geographic areas as one would expect to experience from a traditional paging network. However, there has not yet been a successful integration of paging services with LMR.

Traditional paging solutions offer a means of transferring small amounts of information to a user on a downlink only. There is value however in enabling either an automatic or user initiated response. Various methods which enable a communication back into the paging network are known. A paging device is generally quite small leading to limitations in both transmitter power and antenna efficiency. These limitations result in a range issue. Specifically, the uplink side of such a paging system is the weak link.

### SUMMARY OF THE INVENTION

It is an object of the invention to provide for improved paging techniques which integrate into an LMR network such as P25 or DMR.

In one aspect the invention resides in a method of receiving a paging message at a station in a mobile radio system, including: receiving an RF signal from the system, converting the RF signal into a stream of symbols, using one or more of the symbols to synchronise the station with the RF signal, using one or more of the symbols to identify a paging message rather than a mobile radio message in the RF signal, and converting the stream of symbols into a stream of bits which represents the paging message.

In another aspect the invention also resides in a method of transmitting a paging message in a mobile radio system, including: receiving a bit stream representing the paging message, converting the bit stream into a symbol stream in which one or more symbols identify a paging message rather than a mobile radio message, converting the symbol stream into an RF signal, and transmitting the RF signal from a station in the radio system.

Preferably the same symbols are used for both synchronisation of the station and identification of the paging message. An initial part of the symbol stream includes a correlation sequence which enables synchronisation of the terminal. A double length sequence is preferably used for initial synchronisation. The stream of symbols may include a correlation sequence which represents a user status message.

Preferably the symbol stream may also be relatively long compared with the bit stream so that each bit is represented by multiple symbols. For example, the symbol stream has a rate of 4800 sps and the bit stream has a rate of 200 bps. Alternatively the symbol stream has a rate of 480 sps and the bit stream has a rate of 10 bps. The symbols are preferably wave shapes in which the shape for bit 1 is inverted relative to the shape for a bit 0.

In a further aspect the invention resides in a method of transmitting information in a mobile radio system, including: determining whether the information represents a paging message or a mobile radio message, if a paging message then transmitting the message according to the method of claim 10, and if a mobile radio message then transmitting the message using a mobile radio protocol.

In another aspect the invention resides in a method of receiving a paging message in a mobile radio system, including: receiving an RF signal at a station in the radio system, converting the RF signal into a sampled waveform, determining whether the sampled waveform is a paging message according to a first correlation procedure applied to an initial part of the waveform, and if so, converting the sampled waveform into a bit stream containing the paging message.

Preferably the method further includes determining whether the waveform includes a synchronisation sequence according to a second correlation procedure, and if so, using the sequence to synchronise the station for further processing of the RF signal. The initial part of the waveform used to identify the paging message may also be used for initial synchronisation.

In another aspect the invention resides in a method of receiving information in a mobile radio system, including: using a correlation procedure to determine whether the information represents a paging message, and if so, activating a decoder to interpret the information using a paging protocol, otherwise, enabling a decoder to interpret the information using a mobile radio protocol.

The invention also resides in a station in a mobile radio system which transmits or receives information according to the methods defined above. The station is typically a user terminal or a base station. In general terms a decoding path in the station is switched according to the nature of the symbol stream.

### LIST OF FIGURES

Preferred embodiments of the invention will be described with respect to the accompanying drawings, of which:

FIG. 1 shows a typical traditional wireless paging system.

FIG. 2 shows a traditional paging system existing in the same physical areas as a standard LMR system.

FIG. 3 shows a paging system with responder capability responding into a LMR network.

FIG. 4 shows a paging system based upon an LMR network.

FIG. 5 illustrates use of correlation sequences to communicate data.

FIG. 6 illustrates use of a correlation sequence for initial synchronisation and to distinguish a standard P25 transmission from a paging transmission,

FIG. 7 illustrates a paging transmit line up in relation to FIG. 6,

FIG. 8 illustrates a receiver needed to detect transmissions by the line-up in FIG. 7,

FIG. 9 illustrates a correlation decoder.

FIG. 10 compares waveforms in two correlator stages in the decoder.

FIG. 11 represents a visualisation of the signals observed after correlation.

FIG. 12 shows the modules that may exist in a responding pager.

FIG. 13 is a flow diagram showing the operation of a transmitter.

FIG. 14 illustrates the operation of a receiver to decode information communicated according to FIG. 13.

FIG. 15 illustrates performance in line of sight conditions showing how the paging algorithm operates compared to standard P25.

FIG. 16 illustrates a performance in Rayleigh faded conditions showing how the paging algorithm operates compared to standard P25.

FIG. 17 illustrates a performance in delay spread conditions showing how the paging algorithm operates compared to standard P25.

FIG. 18 illustrates a performance in line of sight conditions for the message error rate.

FIG. 19 illustrates message error rate in Rayleigh faded conditions.

FIG. 20 illustrates message error rate performance in delay spread conditions.

### DESCRIPTION OF PREFERRED EMBODIMENTS

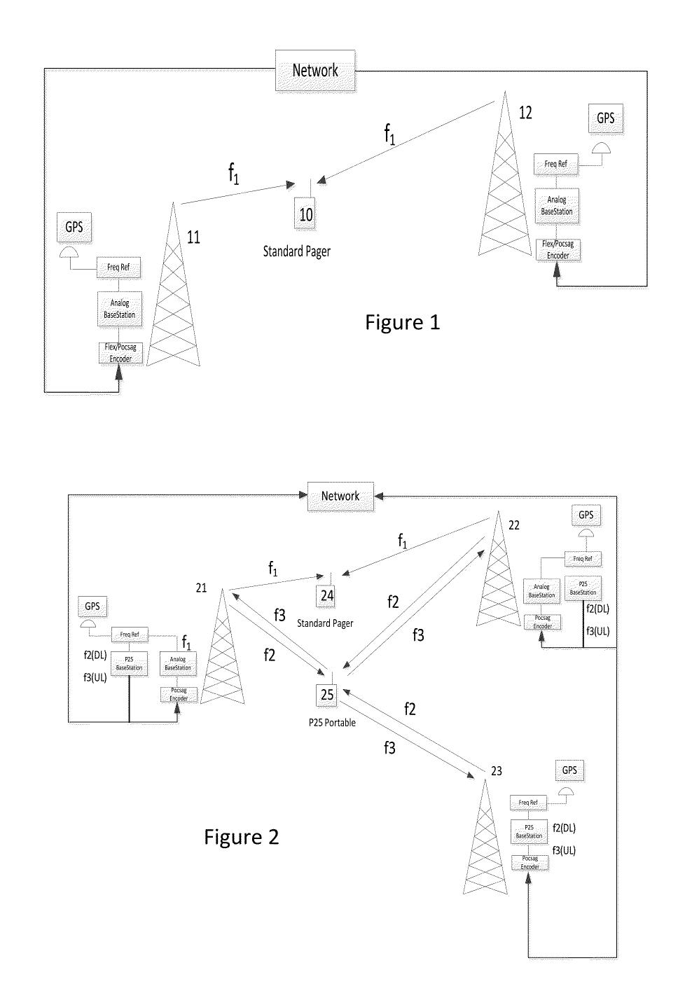

FIG. 1 illustrates a traditional paging architecture in which a message sourced from a network component that may be a dispatch terminal in a Network Operations Centre is transmitted via multiple sites to a traditional paging device 10. Typically, the message to be communicated arrives at a Paging Encoder which then converts it into a form suitable for transmission over the air. For example, in the case of POCSAG transmission, the user message is packaged into a suitable structure, error correction added then converted into an FFSK modulation which can then be converted to radio frequency transmission via an analogue base station.

FIG. 1 shows base sites 11, 12. In a paging system it is common to use the same downlink frequency from each site which is known in the art as simulcast. This form of transmission is made possible through tightly managed transmission time lock afforded through the use of GPS as a timing reference. This timing reference is used to precisely control the launch time of transmissions from each site such that signals arriving at a paging receiver exist within acceptable timing boundaries.

FIG. 2 offers a view showing how a typical P25 system may exist over the same geographic area as a traditional paging system. Here, two sites 21, 22 support both a traditional paging system transmitter 24 as well as a P25 transceiver 25. The other site 23 supports the P25 transceiver only. Implicitly the diagrams highlight how P25 may be located at different sites to paging and the coverage areas may or may not overlap. Further, in this particular case, the figure shows how both the paging system operating on frequency f1 and the P25 system downlinking on frequency f2 exist in a simulcast mode. The uplink frequency of the P25 system is f3. The use of P25 simulcast is shown here by way of example whereas non simulcast may be used.

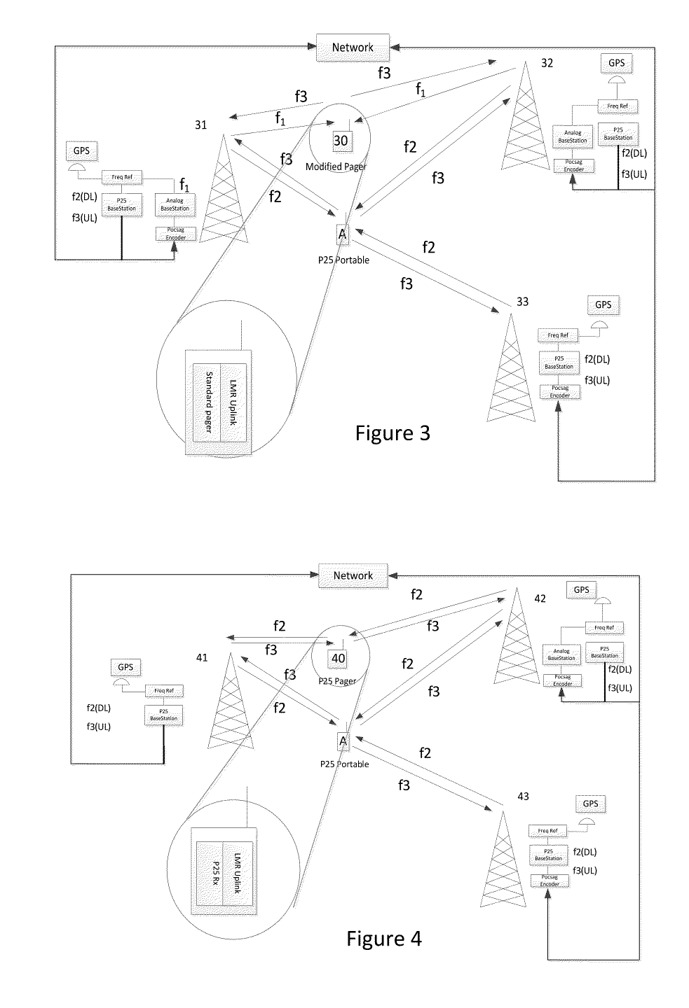

FIG. 3 illustrates a modified paging device 30 which continues to receive traditional paging transmissions (e.g via POCSAG) from base sites 31, 32, 33 but which is also capable of transmitting either standard P25 or a modified version of P25 on the uplink. Effectively this becomes a hybrid system using alternative systems on the downlink and uplink. The uplink frequency used can be the same as a normal P25 channel (i.e f3) whereupon the presence of a unique correlation sequence at the head of the transmission can identify it as a paging signal. Alternatively, the transmission could occur on a separate frequency (f4 not shown) in which case there may be no need at the base station receiver to differentiate between this paging signal and any other type of transmission.

FIG. 4 shows an embodiment in which the paging device 40 is capable of receiving and transmitting from base sites 41, 42, 43 using the same method for both downlink and uplink. In this illustration, standard P25 is used on the downlink and modified P25 on the uplink. An alternative configuration may be the use of standard P25 on the downlink and standard P25 on the uplink but only in the case where the coverage design is capable of supporting the weaker uplink of standard P25 compared to the modified P25. The illustration shows the use of frequency f2 for standard P25 on the downlink and f3 for the transmission of the modified uplink. This is by way of illustration only as it is possible to use any frequency pair or even to operate in a TDMA mode if such a structure exists in the network. Although this implementation is based upon P25, more generally, the approach could apply to other digital modulations such as DMR.

Traditional paging technology uses a low symbol rate. The use of a low symbol rate is advantageous because the energy per symbol transmitted over the air is substantially greater than using a high symbol rate. Generally the use of a low symbol rate results in greater range. Simply lowering the symbol rate however exposes the receiver to the effects of Doppler spread caused by mobility. A solution to this problem is to maintain the underlying modulation rate of P25 whilst extending the energy of a single symbol across a longer period of time. This can be achieved through the use of correlation sequences. A correlation sequence may be relatively long compared to the underlying bit sequence from which the symbols are formed.

Correlation procedures are used for a wide range of tasks in a mobile radio receiver when the receiver is communicating with a base station. In a correlation process, the arriving data is compared, in the form of sample values, with a sequence of symbols or other data items, which are known in the receiver. If the arriving data matches the sequence of known data, a correlation signal is emitted which indicates that the sequence of known data items has been identified in the received signal. Correlator systems in a mobile radio receiver are typically used for carrying out time-slot or frame synchronisation, and delay estimation.

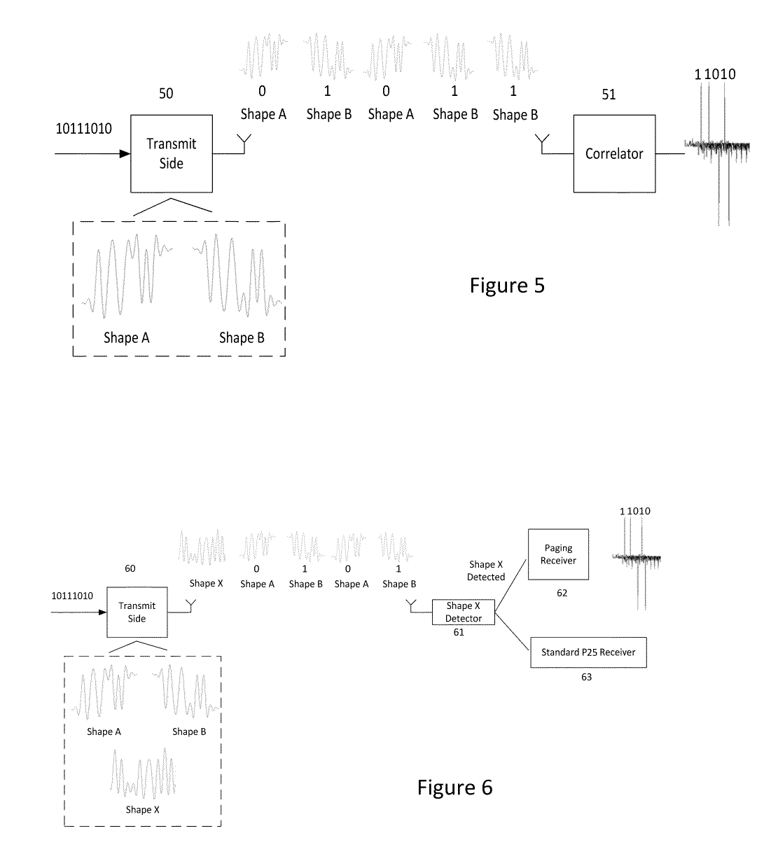

FIG. 5 illustrates a correlator system in which the energy of a single symbol is extended across a relatively long period of time. A bit stream is entering the system from a transmitter 50 where a 1 is translated into a correlation waveform that is transmitted over the air interface using a combination of shapes A and B. In this case the shape of the wave form is transmitted representing a 1 by way of a unique correlation sequence shape B, that happens to be the P25 sequence normally used for synchronisation. If the bit to be transmitted is a zero, then shape A which is the inverse of the sequence for a 1 is used. Conveniently, in this case, shape A represents an inverse sequence of the P25 sequence normally used for synchronisation. At the receive side of the system, a correlator 51 is searching for the waveforms used to represent either 1 or 0. Its output will peak (correlate) when a wave form representing a 1 arrives as this represents the arrival of a bit 1. The same correlation filter structure can be used to detect the inverted waveform used to represent a 0. Upon arrival of this shape, the correlation output will peak negatively representing the arrival of a 0.

FIG. 6 illustrates a further elaboration of the system in FIG. 5, in which a unique correlation sequence shape X is conveyed by transmitter 61 at the start of a stream of symbols which form a transmission burst. This unique sequence is used at the receiver side for two purposes, namely initial synchronisation and also the unique identification of a paging signal as opposed to a standard P25 signal. A detector 62 signals either a paging receiver 63 or a standard P25 receiver 63 according to the result of the correlation process. Two independent sequences can be used for initial synchronisation and identification, but it is convenient to use one signal for both. In an alternative form, a unique correlation sequence could also be used to communicate a specific status message such as “I am responding” or “I am available”.

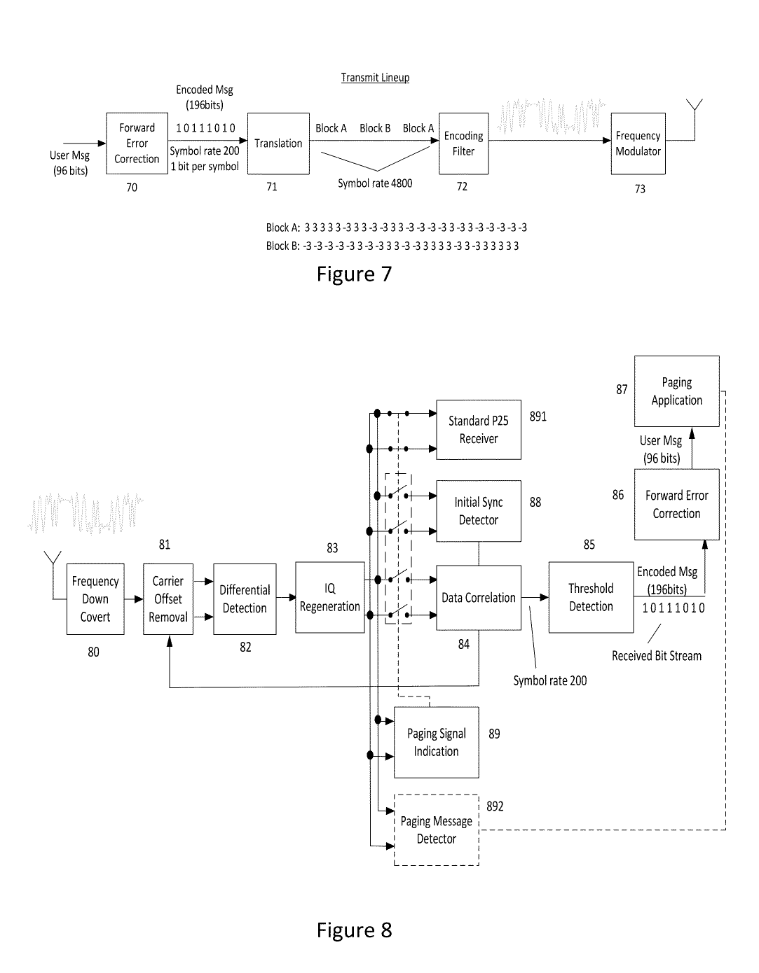

FIG. 7 shows a detailed signal processing structure needed to create the form of transmission described in FIGS. 5 and 6, with a user message of 96 bits, by way of example. This message is encoded using a ½ rate convolutional forward error correction scheme 70 to produce a 196 bit encoded message. This error correction scheme is defined in the APCO P25 standard. The encoded bit stream operates at a symbol rate of just 200 bps and is translated 71 into a symbol stream, or unique correlation sequences or its inverse. This is illustrated as Block A and Block B. In other words, a single bit is now represented as a sequence of 24 symbols which forms the unique correlation sequence. These blocks of symbols which operate at a rate of 4800 symbols per second are chained and are passed through an encoding filter 72 which in the case of P25 is represented as a raised cosine filer followed by an inverse sync. This filtered signal is them modulated 73 onto the air interface.

A standard P25 transmit line up operating at a base line rate of 4800 sps thereby communicates information at a rate of 200 bps along with an associated boost in symbol power and therefore range. The blocks containing symbols at 4800 sps are passed through an encoding Finite Impulse Response (FIR) filter whose coefficients produce a standard P25 modulation. The stream of symbols are an analogue waveform which is then used to frequency modulate a physical transmitter operating at an arbitrary carrier frequency which is generally below 1 GHz and commonly at very high frequency (VHF). In this example the underlying modulation rate (M) is 4800 sps and the bit rate for data transmission (B) is 200 bps, meaning the sequence used to represent a bit is 24 (i.e M/B). Generally any value of M can be used and any value of B as long as the length M/B yields a sequence that has a sufficiently strong autocorrelation property.

FIG. 8 illustrates a receiver structure that could be used to decode the low rate information being communicated by the transmitter shown in FIG. 7. To begin, the signal is down converted 80 from its carrier frequency to baseband In-Phase and Quadrature. It is typical in practical implementations to have a residual carrier present. This is typically removed 81 using a numerically controlled oscillator using a complex multiplication process. The IQ signal is then translated into a frequency representation through observing 82 the difference in phase over a known sample period. Undertaking this process removes the amplitude dependency of the IQ signal. The signal at this point now represents frequency and we convert this back 83 into a pseudo form of IQ with a normalised magnitude. This signal can now enter a correlation algorithm 84 that operates on normalised complex signals. The coefficients of a correlator are configured as the known sequence representing the signal transmitted is the form of the standard P25 sequence while a parallel correlator is searching for the inverted sequence. The output of the complex signal correlation is passed to a threshold algorithm 85 which detects either positive going signals caused by a symbol correlation sequence or negative going signals caused by the inverted symbol correlation sequence. This creates a bit stream that can be passed to a forward error correction stage 86 where the original user message is decoded and passed to the Paging application 87.

The coefficients of a complex FIR filter are the reversed version of the transmitted correlation sequence representing a 1—making the filter act as a correlator. The output of the correlator is shown in equation (1) where subscript ‘c’ represents the coefficients needed for initial synchronisation.

$$\begin{matrix}y = ( {I}_{IN} + {jQ}_{IN} ) ( {I}_{C} + {jQ}_{C} ) \\ = ( {I}_{IN} {I}_{C} - {Q}_{IN} {Q}_{C} ) + j ( {I}_{IN} {Q}_{C} + {Q}_{IN} {I}_{C} )\end{matrix} \qquad ( 1 )$$

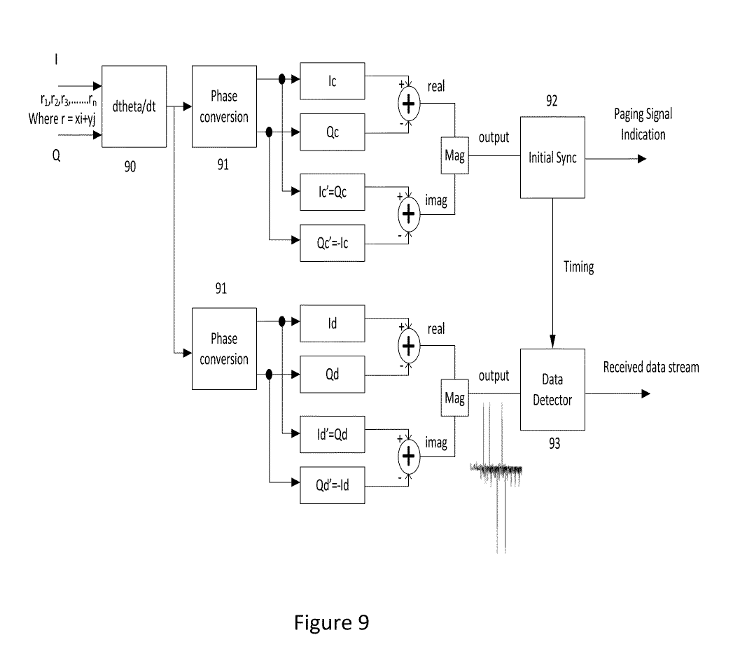

The correlation filter can be visualised as two separate filter banks as shown in FIG. 9, one that produces the real part of the output, and one that produces the imaginary part. The coefficients of the two banks are the same, except that they have been rotated by π/2 radians.

$$\begin{matrix}{I}_{C}^{′} = {Q}_{C} & & {I}_{d}^{′} = {Q}_{d} \\ & and & \\ {Q}_{C}^{′} = - {I}_{C} & & {Q}_{d}^{′} = - {I}_{d}\end{matrix} \qquad ( 2 )$$

Also shown in FIG. 8 is an initial synchronisation detector 88. This represents another correlation algorithm that is searching for the unique sequence that indicates the start of the paging signal and is used to estimate where subsequent data carrying correlations can be expected.

Also shown in FIG. 8 is a paging signal detector 89. This represents another correlation algorithm that is searching for a pattern (possibly the same as initial synchronisation) that identifies the signal as paging. An affirmative indication of this can be used to switch signal paths between a standard P25 receive line up 891 versus the paging path described above.

Further, FIG. 8 shows a paging message detector 892. This represents another optimal (shown in dashed lines) correlating detector that is searching for specific waveform shapes which are pre-defined as representing a known message. If detected the response is passed to the paging application. One example is ‘I am responding’.

FIG. 9 outlines the correlation process according to equation (1). Complex correlation is indicated but real numbers only could also be used. A complex signal r₁, r₂ . . . rₙ arrives at a differential phase process 90. Each complex signal is firstly converted 91 into a phase angle (theta), the difference between two values of theta undertaken over a known period represents frequency. This frequency representation is then converted back into I and Q before the normalised IQ stream is passed into a complex correlation process, one process 92 for detecting an initial sync/paging indicator and the other process 93 for detecting data. Each correlation process contains two sets of coefficients which represent the wanted signal where each set is pi/2 different to each other. The reason for having a pair of correlation coefficients is to avoid a possible problem from the impact of initial phase of the wanted signal.

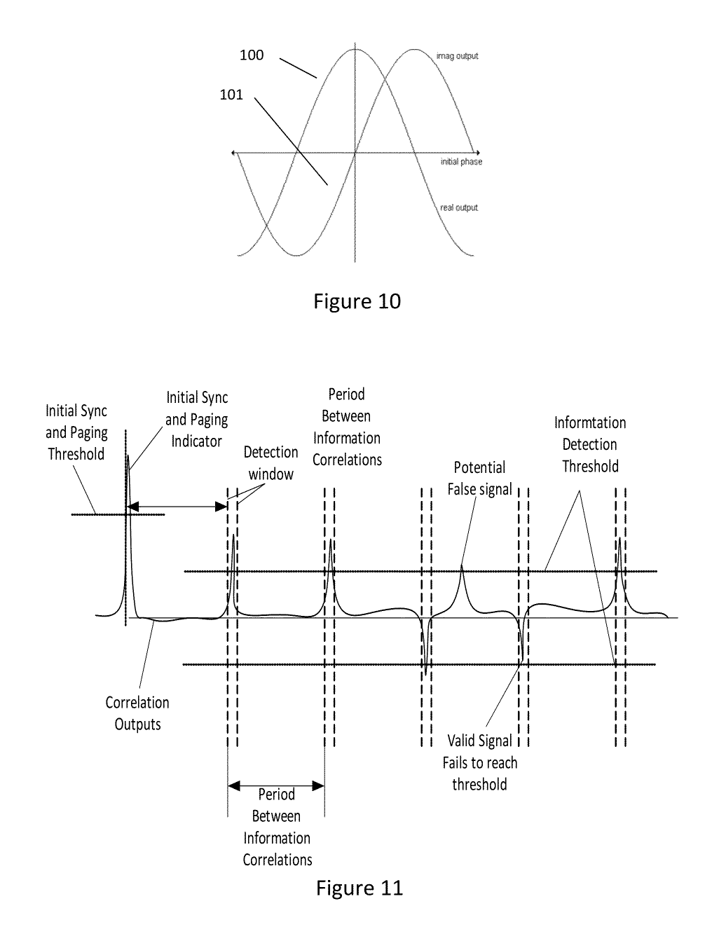

FIG. 10 shows how the output 100 of one bank of correlators in FIG. 9 is dependent upon the initial phase. The output reduces as the initial phase moves away from its nominal position of zero pi. The output 101 from a second correlation bank whose coefficients are pi/2 is compared to the first. Taking the square of the magnitude of each bank then adding the result gives a constant correlation level irrespective of the initial phase.

FIG. 11 shows conceptually the combined output of the correlation process in FIG. 9. A strong initial synchronisation sequence results when the sequence used is twice the length of the waveforms used to represent data. Once initial synchronisation is achieved, a known period exists between this point and the point at which the first data correlation is expected. The receiver uses a small time window to examine if a correlation appears at the expected time. Following this, the expected time of data correlations is known and as such the signal can be examined at each case to estimate what data was sent; either 1 or 0. The example in FIG. 11 represents the transmission of 1,1,0,1,0,1. Also shown is the illustration is a false correlation. The process of using a window to examine expected data minimises the chance of false correlations being interpreted as data.

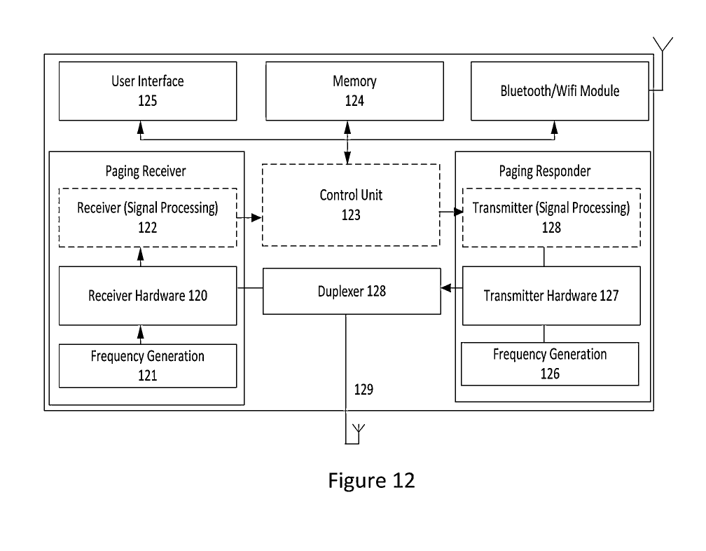

FIG. 12 shows a pager system that incorporates a paging receiver and a paging responder and can be used to carry out the correlation processes described above. Receiver hardware 120 filters and mixes an incoming RF signal from antenna 129 down to signal frequencies that can be operated upon within the digital domain. The receiver requires knowledge of the current RF frequency being received and this is supplied (for the purpose of mixing) from the Frequency Generation system 121. The Frequency generation system creates oscillations of a rate which allow practical mixing to take place of the wanted RF signal. This mixing typically takes place to bring the signal frequency down to a rate which can be quantized for signal processing operation. The Frequency Generation system is typically implemented as a combination of hardware and signal processing. Receiver signal processing 122 then filters, mixes, synchronises and decodes the bit stream to a point where binary decisions can be made to allow the digital signal to be passed to the control unit as bursts of data (or data blocks).

In FIG. 12 a control unit 123 receives the decoded blocks of data and acts upon them according to their content. In this example, the control unit may compare the decoded bursts from slot 1 and slot 2 to establish that they are repeats of one another. Memory 124 contains the implementation code for the algorithms used to decode the wanted signal and process the signal according to the required algorithms. The User interface 125 allows the user to select a range of options typically available on a radio of this type such as channel, user ID, signal strength, encryption keys, menu navigation. A Bluetooth or other transmitter may also be provided.

When the base station in FIG. 12 begins a transmission, a data block is created within the control unit 123. The burst of data is then passed through a signal processing chain to be processed into a waveform suitable for transmission on the air interface. In a DMR system, a key element is an encoding filter which is described as a Route Raise Cosine filter of alpha value 0.2. This shapes the waveform for transmission before it is mixed back up to RF frequencies. Frequency generation subsystem 126 is used to supply the relevant mixing components to pass the signal up to an intermediate stage ready for processing by the transmitter hardware 127. A Duplexer 128 is typically used at the front end of the transceiver to allow dual reception and transmission. Received signal operating on carrier frequency 1 is passed from the antenna 129 through to the receiver line-up. Transmitted signal operating on carrier frequency 2 is passed out from the transmitter line-up to the antenna 129.

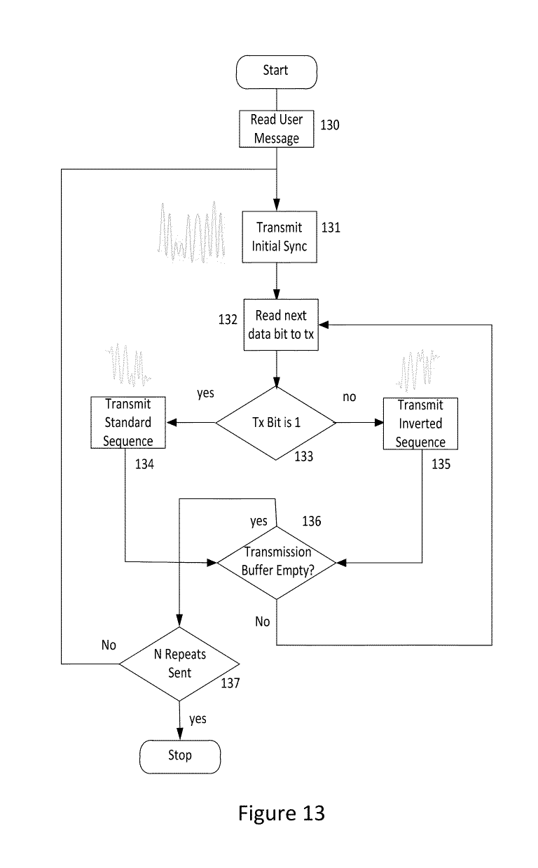

FIG. 13 outlines a process used to transmit a user message 130. It is assumed the bit stream has already had error correction applied and this may represent the half rate convolution code defined in P25 phase I. Several repeats of the same message may be sent (defined here as N). Sending repeats increases the reliability of the communication. To begin, an initial synchronisation sequence is transmitted 131. The next bit is then read 132 from a transmission buffer and tested 133. If the next bit is a 1 then a standard correlation sequence is sent 134. If the next bit is a zero then the inverted correlation sequence is sent 135. Here the standard correlation sequence we use is the synchronisation pattern from P25 phase I. This process of selecting the next bit to be sent continues until the transmission buffer is empty 136. To increase the reliability, the whole message may be repeated 137 a number of times N. This represents a repeat of this flow diagram which is not shown. The repeated transmissions are sent at a time that is symbol synchronised with the first transmission to aid in diversity combining at the receiver. It should be noted that if messages are repeated then the repeated message is sent in precise symbol synchronisation compared to the preceding messages of the same information. This is undertaken to enable diversity combining in a receiver if required.

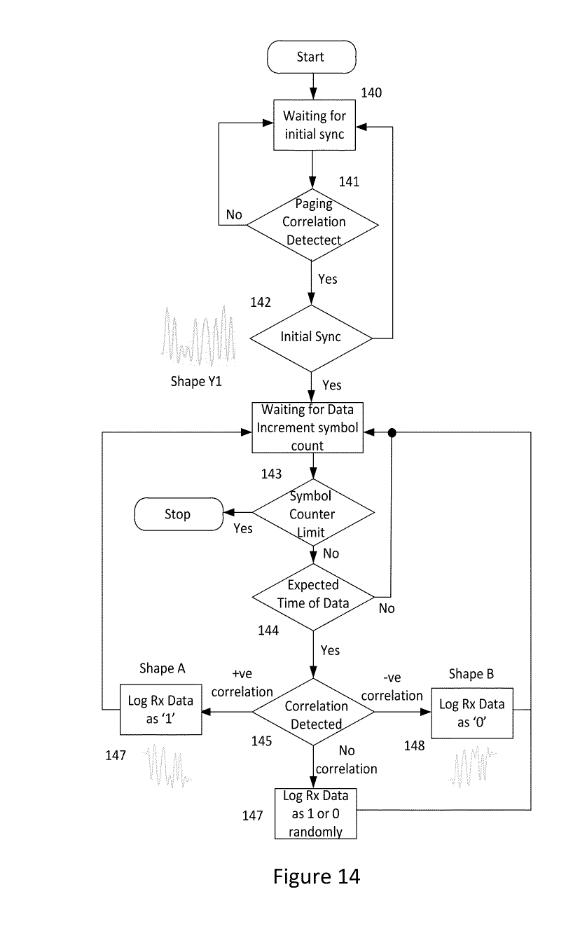

FIG. 14 outlines a process used to receive a message. To begin, the receiver is simply waiting 140 for arrival of the first signal. If correlation occurs 141, the result is examined to see if the arrival is a paging signal. Assuming it is a paging signal then the same signal may represent initial synchronisation 142, otherwise the receiver continues to wait. Following initial synchronisation, there is a specified period of time for arrival of data correlations, determined by symbol counting 143. If after an expected time 144 a correlation is detected 145 then result may be a 1 or a 0, otherwise a random result may be allocated 146. A positive correlation is logged 147 as a 1. Alternatively a negative correlation is logged 148 as a zero. This process continues until the end of an expected data block has been reached.

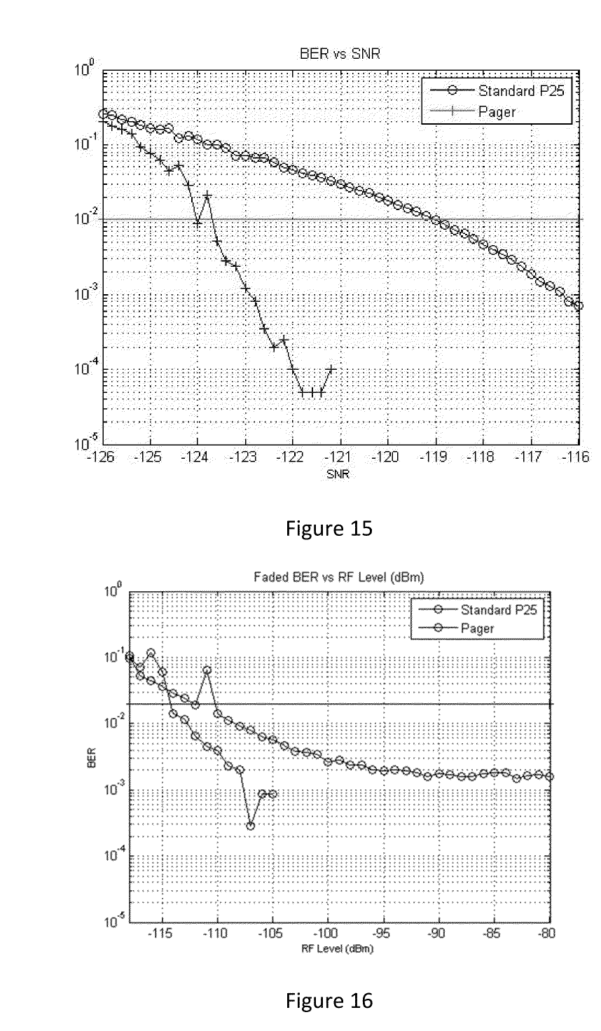

FIG. 15 illustrates Bit Error Rate performance based on the use of correlations representing data. As a point of reference, the error rate performance is compared against standard P25. Typically, P25 reaches a 1% BER at around −119 dBm assuming the use of a simple differential based receiver. Also shown in the figure is the performance observed using an algorithm as described above. In this particular case, there is a 1% BER at approximately −124 dBm which represents a 5 dB improvement. Greater improvements can be acquired by slowing the paging symbol rate further or selecting enhanced forms of receiver.

FIG. 16 illustrates the performance in a faded environment. These results represent a fade rate of around 80 Hz which is substantially higher than expected if operating at VHF at vehicle speeds. Nevertheless, the typical performance of P25 reception in the presence of a differential receiver has a residual error rate even under good signal strength. With the paging receiver however, there is a rapidly decreasing error rate with signal strength such that under higher SNR the error rate becomes substantially low with a minimal residual BER.

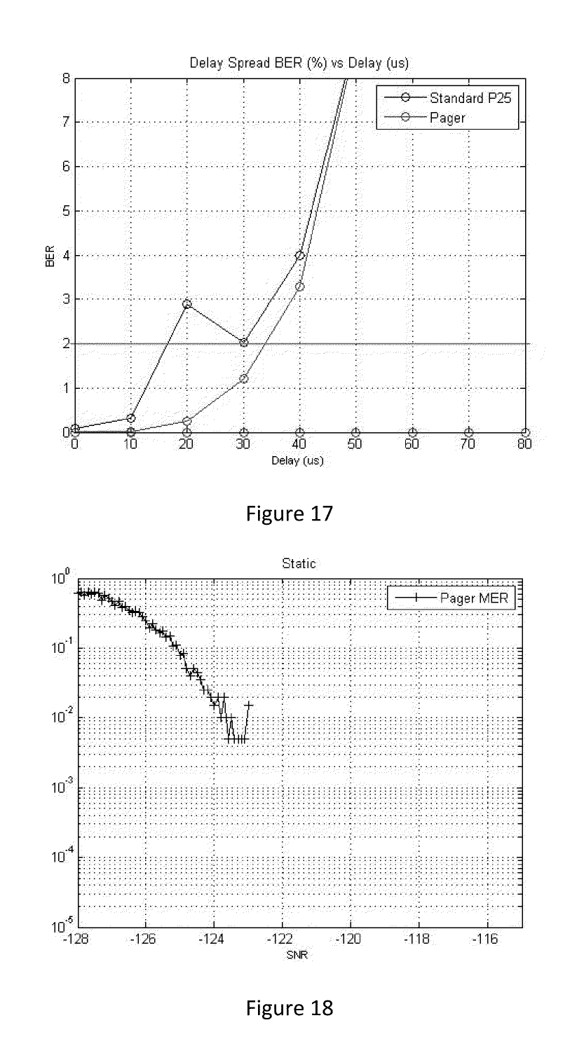

FIG. 17 shows the performance in the presence of delay spread representing two equal power rays arriving at the candidate receiver whereupon each path is independently Rayleigh faded. The typical performance of P25 is a 2% bit error rate at around 30 uS. The paging receiver matches this and offers a slight improvement.

FIG. 18 shows the message error rate of the system described above. Here a 10% message error rate occurs at −125 dBm. Sending repeats of the same message yields an increase in reliability where for example, the probability of a first copy of message. A getting through is 90% whereas the probability of either the first or a second copy of message. A getting through becomes 99% assuming the two messages experience uncorrelated channel conditions.

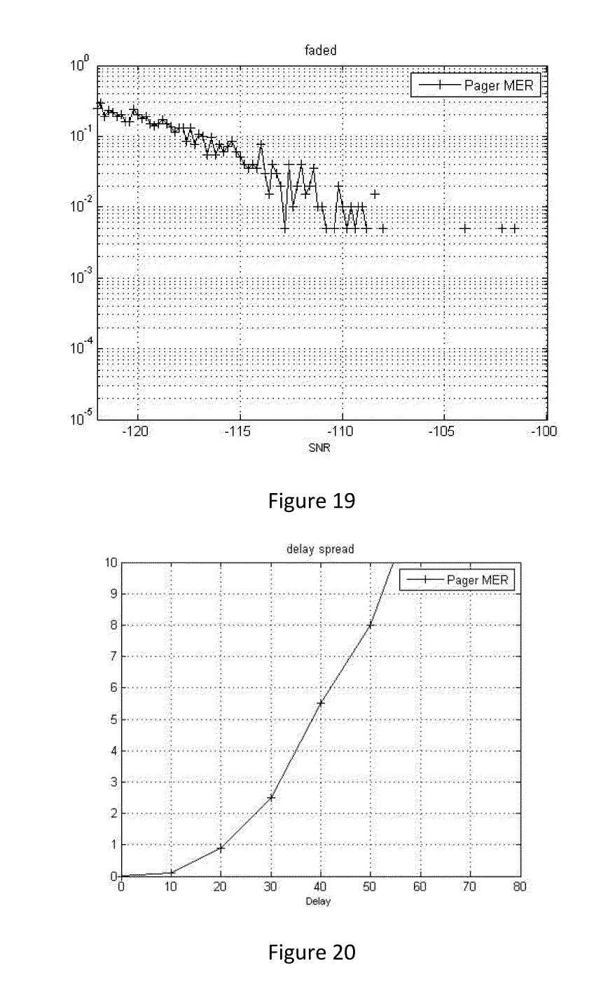

FIG. 19 shows the message error rate performance in Rayleigh faded conditions where in this case, a speed of 100 km/h at 800 MHz operation was assumed. This represents an extreme RF condition for the operation of the paging system where operation is likely to occur in VHF.

FIG. 20 shows the message error rate in delay spread conditions where again extreme conditions were assumed with two independently Rayleigh Faded paths were assumed for operation at 800 MHz and 60 km/h.

1. A method of receiving a paging message at a station in a mobile radio system, comprising:
receiving an RF signal from the system;
converting the RF signal into a stream of symbols;
using one or more of the symbols to synchronise the station with the RF signal;
using one or more of the symbols to identify a paging message rather than a mobile radio message in the RF signal; and
converting the stream of symbols into a stream of bits which represents the paging message.

2. A method according to claim 1 wherein the same symbols are used for both synchronisation of the station and identification of the paging message.

3. A method according to claim 1 wherein an initial part of the symbol stream includes a correlation sequence which enables synchronisation of the terminal.

4. A method according to claim 1 wherein a double length sequence is preferably used for initial synchronisation.

5. A method according to claim 1 wherein the stream of symbols includes a correlation sequence which represents a user status message.

6. A method according to claim 1 wherein the symbol stream is relatively long compared with the bit stream so that each bit is represented by multiple symbols.

7. A method according to claim 1 wherein the symbol stream has a rate of 4800 sps and the bit stream has a rate of 200 bps.

8. A method according to claim 1 wherein the symbol stream has a rate of 480 sps and the bit stream has a rate of 10 bps.

9. A method according to claim 1 wherein the symbols are wave shapes in which the shape for bit 1 is inverted relative to the shape for a bit 0.

10. A method of transmitting a paging message in a mobile radio system, comprising:
receiving a bit stream representing the paging message;
converting the bit stream into a symbol stream in which one or more symbols identify a paging message rather than a mobile radio message;
converting the symbol stream into an RF signal; and
transmitting the RF signal from a station in the radio system.

11. A method according to claim 10 wherein each bit in the bit stream is converted into multiple symbols in the symbol stream.

12. A method according to claim 10 wherein the symbols are wave shapes in which the shape for bit 1 is inverted relative to the shape for a bit 0.

13. A method according to claim 12 wherein the wave shapes are derived from a mobile radio protocol.

14. A method of transmitting information in a mobile radio system, including:
determining whether the information represents a paging message or a mobile radio message,
if a paging message then transmitting the message according to the method of claim 10, and
if a mobile radio message then transmitting the message using a mobile radio protocol.

15. A method of receiving a paging message in a mobile radio system, comprising:
receiving an RF signal at a station in the radio system;
converting the RF signal into a sampled waveform;
determining whether the sampled waveform is a paging message according to a first correlation procedure applied to an initial part of the waveform; and
if the sampled waveform is a paging message, converting the sampled waveform into a bit stream containing the paging message.

16. A method according to claim 15 wherein the waveform is a symbol stream in which multiple symbols represent single bits.

17. A method according to claim 15 further comprising:
determining whether the waveform includes a synchronisation sequence according to a second correlation procedure, and if so,
using the sequence to synchronise the station for further processing of the RF signal.

18. A method according to claim 15 wherein the initial part of the waveform used to identify the paging message is also used for initial synchronisation.

19. A method of receiving information in a mobile radio system, comprising:
using a correlation procedure to determine whether the information represents a paging message;
if the information represents a paging message, activating a decoder to interpret the information using a paging protocol; and
otherwise, enabling a decoder to interpret the information using a mobile radio protocol.
